(19) United States
(12) Patent Application Publication
(10) Pub. No.: US 2011/0166861 A1
(43) Pub. Date: Jul. 7, 2011

(54) METHOD AND APPARATUS FOR SYNTHESIZING A SPEECH WITH INFORMATION

(75) Inventors: Xi Wang, Beijing (CN); Jian Luan, Beijing (CN); Jian Li, Beijing (CN)

(73) Assignee: KABUSHIKI KAISHA TOSHIBA, Tokyo (JP)

(21) Appl. No.: 12/888,655

(22) Filed: Sep. 23, 2010

Related U.S. Application Data
(63) Continuation of application No. PCT/IB2010/050002, filed on Jan. 4, 2010.

(51) Int. Cl. G10L 13/08

(52) U.S. Cl. 704/260; 704/E13.011

(57) ABSTRACT

According to one embodiment, an apparatus for synthesizing a speech, comprises an inputting unit configured to input a text sentence, a text analysis unit configured to analyze the text sentence so as to extract linguistic information, a parameter generation unit configured to generate a speech parameter by using the linguistic information and a pre-trained statistical parameter model, an embedding unit configured to embed information into the speech parameter, and a speech synthesis unit configured to synthesize the speech parameter with the information embedded by the embedding unit into a speech with the information.

### CROSS REFERENCE TO RELATED APPLICATIONS

This is a Continuation Application of PCT Application No. PCT/IB2010/050002, filed Jan. 4, 2010, which was published under PCT Article 21(2) in English.

### FIELD

Embodiments described herein relate generally to information processing technology.

### BACKGROUND

Currently, speech synthesis system is applied in various areas and brings much convenience for people's life. Unlike most audio products where the watermark is embedded to protect the copyright, the synthesized speech is seldom protected even in some commercial products. The synthesized speech is built from the speech database recorded by professional speakers by using a complex synthesis algorithm, and it is important to protect their voice. Furthermore, many TTS applications require some supplementary information to be embedded in the synthesized speech with least affection on the speech signal, such as text information to be embedded in the speech in some web applications. However, it costs too much to add a separate watermark module for a TTS system since the whole TTS system is complex for the limitation of system complexity and hardware requirements.

### BRIEF DESCRIPTION OF THE DRAWINGS

FIG. 1 is a flowchart showing a method for synthesizing a speech with information according to an embodiment.

FIG. 2 shows an example of embedding information in a speech parameter according to the embodiment.

FIG. 3 shows another example of embedding information in a speech parameter according to the embodiment.

FIG. 4 is a block diagram showing an apparatus for synthesizing a speech with information according to another embodiment.

FIG. 5 shows an example of an embedding unit configured to embed information in a speech parameter according to the other embodiment.

FIG. 6 shows another example of an embedding unit configured to embed information in a speech parameter according to the other embodiment.

### DETAILED DESCRIPTION

In general, according to one embodiment, an apparatus for synthesizing a speech, comprises: an inputting unit configured to input a text sentence; a text analysis unit configured to analyze said text sentence so as to extract linguistic information; a parameter generation unit configured to generate a speech parameter by using said linguistic information and a pre-trained statistical parameter model; an embedding unit configured to embed information into said speech parameter; and a speech synthesis unit configured to synthesize said speech parameter with said information embedded by said embedding unit into a speech with said information.

Next, a detailed description of embodiments will be given in conjunction with the drawings.

Method for synthesizing a speech with information

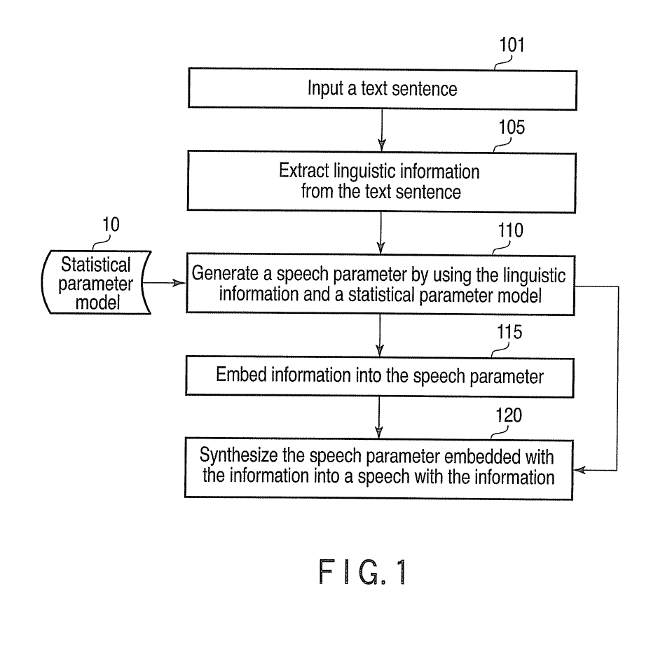

FIG. 1 is a flowchart showing a method for synthesizing a speech with information according to an embodiment. Next, the embodiment will be described in conjunction with the drawing.

As shown in FIG. 1, first in step 101, a text sentence is inputted. In the embodiment, the text sentence inputted can be any text sentence known by those skilled in the art and can be a text sentence of any language such as Chinese, English, Japanese etc., and the present embodiment has no limitation on this.

Next, in step 105, the text sentence inputted is analyzed by using a text analysis method to extract linguistic information from the text sentence inputted. In the embodiment, the linguistic information includes context information, and specifically includes length of the text sentence, and character, pinyin, phoneme type, tone type, part of speech, relative position, boundary type with a previous/next character (word) and distance from/to a previous/next pause etc. of each character (word) in the text sentence. Further, in the embodiment, the text analysis method for extracting the linguistic information from the text sentence inputted can be any method known by those skilled in the art, and the present embodiment has no limitation on this.

Next, in step 110, a speech parameter is generated by using the linguistic information extracted in step 105 and a pre-trained statistical parameter model 10.

In the embodiment, the statistical parameter model 10 is trained in advance by using training data. The process for training the statistical parameter model will be described briefly below. Firstly, a speech database is recorded from one or more speakers such as a professional broadcaster as the training data. The speech database includes a plurality of text sentences and speeches corresponding to each of the text sentences. Next, a text sentence of the speech database is analyzed to extract linguistic information, i.e. context information. Meanwhile, a speech corresponding to the text sentence is analyzed to obtain a speech parameter. Here, the speech parameter includes a pitch parameter and a spectrum parameter. The pitch parameter describes a fundamental frequency of vocal cords resonances, i.e. a reciprocal of a pitch period, which denotes the periodicity caused by vocal fold vibration when a voiced speech is spoken. The spectrum parameter describes a response characteristic of amplitude and frequency of vocal system that airflow passes by to produce sound track, which is got by short time analysis. Aperiodicity analysis is performed for a more precise analysis to extract aperiodic component of a speech signal for generating more accuracy excitation for later synthesis. Next, according to the context information, the speech parameters are clustered by using a statistic method as the statistical parameter model. The statistical parameter model includes description of a set of model units (a unit can be a phoneme, syllable and etc.) parameter related to context information, which is described with an expression of the parameter, such as Gaussian distribution for a HMM (Hidden Markov Model) or other mathematical forms. Generally, the statistic parameter model includes information related to pitch, spectrum, duration etc.

In the embodiment, any training method known by those skilled in the art such as the training method described in the non-patent reference 1 can be used to training the statistic parameter model, and the present embodiment has no limitation on this. Moreover, in the embodiment, the statistic parameter model trained can be any model used in the parameter based speech synthesis system such as the HMM model etc., and the present embodiment has no limitation on this.

In the embodiment, in step 110, the speech parameter is generated by using a parameter recovering algorithm based on the linguistic information extracted in step 105 and the statistical parameter model. In the embodiment, the parameter recovering algorithm can be any parameter recovering algorithm known by those skilled in the art such as that described in non-patent reference 3 (“Speech Parameter Generation Algorithm for HMM-based Speech Synthesis”, Keiichi Tokuda, etc. ICASSP2000, all of which are incorporated herein by reference), and the present embodiment has no limitation on this. Moreover, in the embodiment, the speech parameter generated in step 110 includes a pitch parameter and a spectrum parameter.

Next, in step 115, preset information is embedded into the speech parameter generated in step 110. In the embodiment, the information to be embedded can be any information needed to be embedded in a speech, such as copyright information or text information etc., and the present embodiment has no limitation on this. Moreover, the copyright information, for example, includes a watermark, and the present embodiment has no limitation on this.

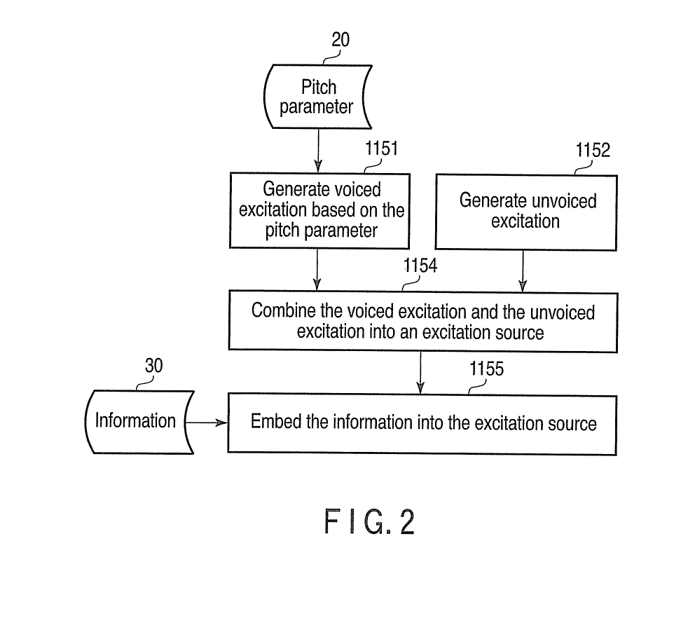

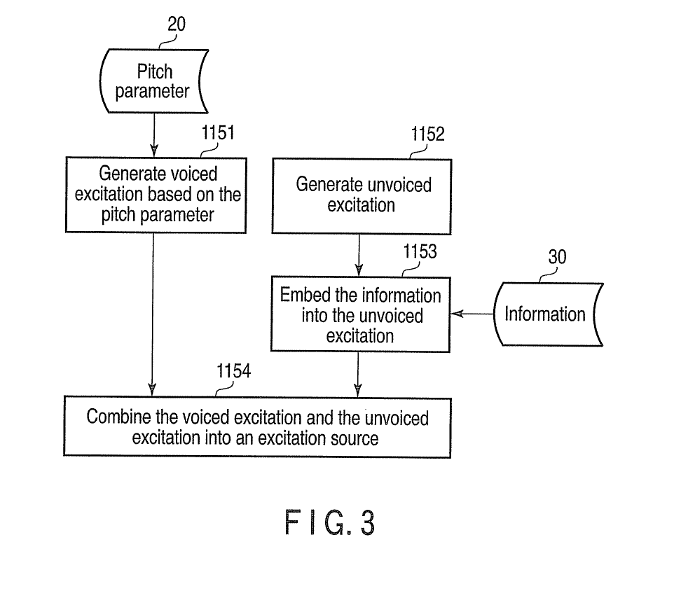

Next, methods of embedding information in a speech parameter of the present embodiment will be described in detail in conjunction with FIGS. 2 and 3.

FIG. 2 shows an example of embedding information in a speech parameter according to the embodiment. As shown in FIG. 2, first, in step 1151, voiced excitation is generated based on the pitch parameter of the speech parameter generated in step 110. Specifically, a pitch pulse sequence is generated as the voiced excitation by a pulse sequence generator with the pitch parameter. Moreover, in step 1152, an unvoiced excitation is generated. Specifically, a pseudo random noise is generated as the unvoiced excitation by a pseudo random noise number generator. In the embodiment, it should be understood that there is no limitation on the sequence for generating the voiced excitation and the unvoiced excitation.

Next, in step 1154, the voiced excitation and the unvoiced excitation are combined into an excitation source with U/V (unvoiced/voiced) decision in a time sequence. Generally, the excitation source is composed of a voiced part and an unvoiced part in a time sequence. The U/V decision is determined based on whether there is a fundamental frequency. The excitation of the voiced part is generally denoted by a fundamental frequency pulse sequence or excitation mixed with aperiodic components (such as a noise) and periodic components (such as a periodic pulse sequence), and the excitation of the unvoiced part is generally generated by white noise simulation.

In the embodiment, there is no limitation on the method for generating the unvoiced excitation and the voiced excitation and the method for combining them, and detail description can be seen in non-patent reference 4 (“Mixed Excitation for HMM-base Speech Synthesis”, T. Yoshimura, etc. in Eurospeech 2001, all of which are incorporated herein by reference).

Next, in step 1155, preset information 30 is embedded into the excitation source combined in step 1154. In the embodiment, the information 30 is for example copyright information or text information etc. Before embedding, the information is firstly encoded as a binary code sequence m={−1, +1}. Then, a pseudo random noise PRN is generated by a pseudo random number generator. Then, the pseudo random noise PRN is multiplied with the binary code sequence m to transfer the information 30 as a sequence d. In the embedding process, the excitation source is used as a host signal S for embedding the information and a excitation source S′ with the information 30 is generated by adding the sequence d into the host signal S. Specifically, it can be denoted by the following formulae (1) and (2).

S′=S+d (1)

d=m*PRN (2)

It should be understood that the method for embedding the information 30 is only an example of embedding information in a speech parameter of the present embodiment, any embedding method known by those skilled in the art can be used in the embodiment and the present embodiment has no limitation on this.

In the embedding method with reference to FIG. 2, the information needed is embedded in the excitation source combined. Next, another example will be described with reference to FIG. 3, wherein the information needed is embedded in an unvoiced excitation before combined.

FIG. 3 shows another example of embedding information in a speech parameter according to the embodiment. As shown in FIG. 3, firstly, a voiced excitation is generated in step 1151 based on the pitch parameter in the speech parameter generated in step 110 and an unvoiced excitation is generated in step 1152, which are same with the example described with reference FIG. 2 and detail description of which is omitted.

Next, in step 1153, preset information 30 is embedded in the unvoiced excitation generated in step 1152. In the embodiment, the method for embedding the information 30 in the unvoiced excitation is same with the method for embedding the information 30 in the excitation source, and before embedding, the information 30 is firstly encoded as a binary code sequence m={−1, +1}. Then, a pseudo random noise PRN is generated by a pseudo random number generator. Then, the pseudo random noise PRN is multiplied with the binary code sequence m to transfer the information 30 as a sequence d. In the embedding process, the unvoiced excitation is used as a host signal U for embedding the information and a unvoiced excitation U′ with the information 30 is generated by adding the sequence d into the host signal U. Specifically, it can be denoted by the following formulae (3) and (4).

U′=U+d (3)

d=m*PRN (4)

Next, in step 1154, the voiced excitation and the unvoiced excitation with the information 30 are combined into an excitation source with U/V decision in a time sequence.

Return to FIG. 1, after the information is embedded in the speech parameter by using the methods described with reference to FIGS. 2 and 3, in step 120, the speech parameter with the information 30 is synthesized into a speech with the information.

In the embodiment, in step 120, a synthesis filter is firstly built based on the spectrum parameter of the speech parameter generated in step 110, and then the excitation source embedded with the information is synthesized into the speech with the information by using the synthesis filter, i.e. the speech with the information is obtained by passing the excitation source through the synthesis filter. In the embodiment, there is no limitation on the method for building the synthesis filter and the method for synthesizing the speech by using the synthesis filter, and any method known by those skilled in the art such as those described in non-patent reference 1 can be used.

Moreover, in the embodiment, the information in the synthesized speech can be detected after the speech with the information is synthesized.

Specifically, in the case where the information is embedded in the excitation source by using the method described with reference to FIG. 2, the information can be detected by using the following method.

Firstly, an inverse filter is built based on the spectrum parameter of the speech parameter generated in step 110. The method for building the revere filter is contrary to the method for building the synthesis filter, and the purpose of the inverse filter is to separating the excitation source from the speech. Any method known by those skilled in the art can be used to build the inverse filter.

Next, the excitation source with the information is separated from the speech with the information by using the inverse filter, i.e. the excitation source S′ with the information 30 before synthesized in step 120 can be obtained by passing the speech with the information through the inverse filter.

Next, the binary code sequence m is obtained by calculating a correlation function between the excitation source S′ with the information 30 and the pseudo random sequence PRN used when the information 30 is embedded into the excitation source S with the following formula (5).

$$m = sign ( Cor ( PRN , {S}^{′} ) ) = \{ \begin{matrix}+ 1 … Cor ( PRN , {S}^{′} ) \\ - 1 … otherwise\end{matrix} \} \qquad ( 5 )$$

Finally, the information 30 is obtained by decoding the binary code sequence m. Here, the pseudo random sequence PRN used when the information 30 is embedded into the excitation source S is the secret key for detecting the information 30.

Moreover, in the case where the information is embedded in the unvoiced excitation by using the method described with reference to FIG. 3, the information can be detected by using the following method.

Firstly, an inverse filter is built based on the spectrum parameter of the speech parameter generated in step 110. The method for building the revere filter is contrary to the method for building the synthesis filter, and the purpose of the inverse filter is to separating the excitation source from the speech. Any method known by those skilled in the art can be used to build the inverse filter.

Next, the excitation source with the information is separated from the speech with the information by using the inverse filter, i.e. the excitation source S′ with the information 30 before synthesized in step 120 can be obtained by passing the speech with the information through the inverse filter.

Next, the unvoiced excitation U′ with the information 30 is separated from the excitation source S′ with the information 30 by U/V decision. Here, the U/V decision is similar to that described above, detail description of which is omitted.

Next, the binary code sequence m is obtained by calculating a correlation function between the unvoiced excitation U′ with the information 30 and the pseudo random sequence PRN used when the information 30 is embedded into the unvoiced excitation U with the following formula (6).

$$m = sign ( Cor ( PRN , {U}^{′} ) ) = \{ \begin{matrix}+ 1 … Cor ( PRN , {U}^{′} ) \\ - 1 … otherwise\end{matrix} \} \qquad ( 6 )$$

Finally, the information 30 is obtained by decoding the binary code sequence m. Here, the pseudo random sequence PRN used when the information 30 is embedded into the unvoiced excitation U is a secret key for detecting the information 30.

Through the method for synthesizing a speech with information of the embodiment, the information needed can be embedded skillfully and properly in a parameter based speech synthesis system and high quality speech with many merits such as low complexity, safe and etc. can be achieved. Moreover, comparing with a general method of embedding information after a speech is synthesized, the method of the embodiment can ensure the confidentiality of the information-embedding algorithm and can greatly reduce computation cost and storage requirement, especially for small-footprint application. Moreover, it is safer to integrate an information-embedding module into a speech synthesis system since it needs more effort to keep this module away from the system. Moreover, if information is only added into the unvoiced excitation, it will be less perceptible to human hearing.

Apparatus for synthesizing a speech with information

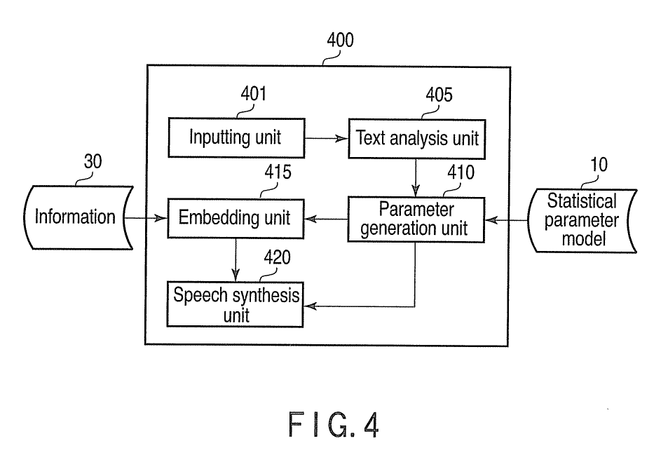

Based on the same concept of the embodiment, FIG. 4 is a block diagram showing an apparatus for synthesizing a speech with information according to another embodiment. The description of this embodiment will be given below in conjunction with FIG. 4, with a proper omission of the same content as those in the above-mentioned embodiments.

As shown in FIG. 4, an apparatus 400 for synthesizing a speech with information according to the embodiment comprises: an inputting unit 401 configured to input a text sentence; a text analysis unit 405 configured to analyze said text sentence inputted by said inputting unit 401 so as to extract linguistic information; a parameter generation unit 410 configured to generate a speech parameter by using said linguistic information extracted by said text analysis unit 405 and a pre-trained statistical parameter model; an embedding unit 415 configured to embed preset information 30 into said speech parameter; and a speech synthesis unit 420 configured to synthesize said speech parameter with said information embedded by said embedding unit 415 into a speech with said information 30.

In the embodiment, the text sentence inputted by the inputting unit 401 can be any text sentence known by those skilled in the art and can be a text sentence of any language such as Chinese, English, Japanese etc., and the present embodiment has no limitation on this.

The text sentence inputted is analyzed by the text analysis unit 405 to extract linguistic information from the text sentence inputted. In the embodiment, the linguistic information includes context information, and specifically includes length of the text sentence, and character, pinyin, phoneme type, tone type, part of speech, relative position, boundary type with a previous/next character (word) and distance from/to a previous/next pause etc. of each character (word) in the text sentence. Further, in the embodiment, the text analysis method for extracting the linguistic information from the text sentence inputted can be any method known by those skilled in the art, and the present embodiment has no limitation on this.

A speech parameter is generated by the parameter generation unit 410 based on the linguistic information extracted by the text analysis unit 405 and a pre-trained statistical parameter model 10.

In the embodiment, the statistical parameter model 10 is trained in advance by using training data. The process for training the statistical parameter model will be described briefly below. Firstly, a speech database is recorded from one or more speakers such as a professional broadcaster as the training data. The speech database includes a plurality of text sentences and speeches corresponding to each of the text sentences. Next, a text sentence of the speech database is analyzed to extract linguistic information, i.e. context information. Meanwhile, a speech corresponding to the text sentence is analyzed to obtain a speech parameter. Here, the speech parameter includes a pitch parameter and a spectrum parameter. The pitch parameter describes a fundamental frequency of vocal cords resonances, i.e. a reciprocal of a pitch period, which denotes the periodicity caused by vocal fold vibration when a voiced speech is spoken. The spectrum parameter describes a response characteristic of amplitude and frequency of vocal system that airflow passes by to produce sound track, which is got by short time analysis. Aperiodicity analysis is performed for a more precise analysis to extract aperiodic component of a speech signal for generating more accuracy excitation for later synthesis. Next, according to the context information, the speech parameters are clustered by using a statistic method as the statistical parameter model. The statistical parameter model includes description of a set of model units (a unit can be a phoneme, syllable and etc.) parameter related to context information, which is described with an expression of the parameter, such as Gaussian distribution for a HMM (Hidden Markov Model) or other mathematical forms. Generally, the statistic parameter model includes information related to pitch, spectrum, duration etc.

In the embodiment, any training method known by those skilled in the art such as the training method described in the non-patent reference 1 can be used to training the statistic parameter model, and the present embodiment has no limitation on this. Moreover, in the embodiment, the statistic parameter model trained can be any model used in the parameter based speech synthesis system such as the HMM model etc., and the present embodiment has no limitation on this.

In the embodiment, the speech parameter is generated by using a parameter recovering algorithm by the parameter generation unit 410 based on the linguistic information extracted by the text analysis unit 405 and the statistical parameter model. In the embodiment, the parameter recovering algorithm can be any parameter recovering algorithm known by those skilled in the art such as that described in non-patent reference 3 (“Speech Parameter Generation Algorithm for HMM-based Speech Synthesis”, Keiichi Tokuda, etc. ICASSP2000, all of which are incorporated herein by reference), and the present embodiment has no limitation on this. Moreover, in the embodiment, the speech parameter generated by the parameter generation unit 410 includes a pitch parameter and a spectrum parameter.

Preset information is embedded by the embedding unit 415 into the speech parameter generated by the parameter generation unit 410. In the embodiment, the information to be embedded can be any information needed to be embedded in a speech, such as copyright information or text information etc., and the present embodiment has no limitation on this. Moreover, the copyright information, for example, includes a watermark, and the present embodiment has no limitation on this.

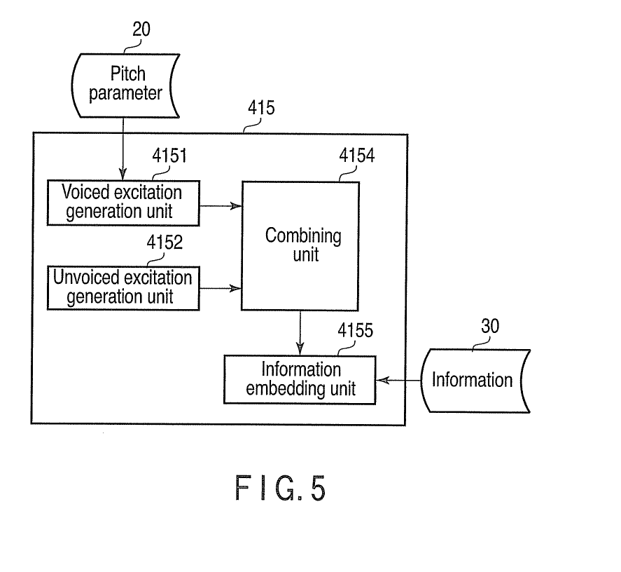

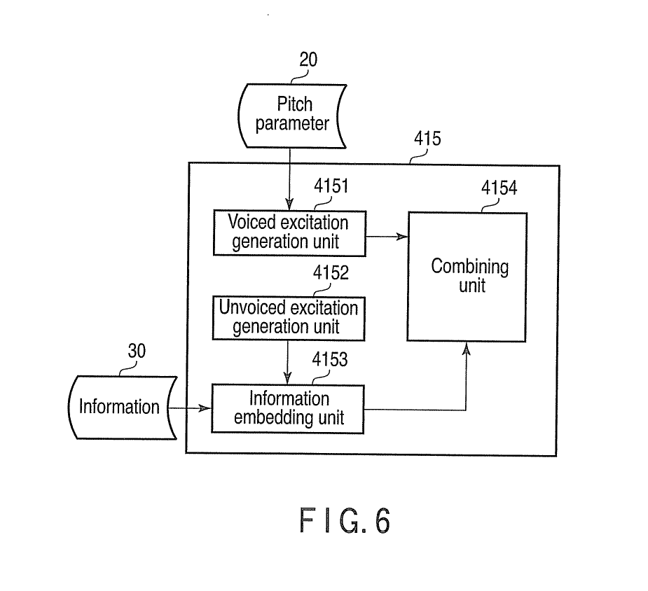

Next, the embedding unit 415 of embedding information in a speech parameter of the present embodiment will be described in detail in conjunction with FIGS. 5 and 6.

FIG. 5 shows an example of the embedding unit 415 configured to embed information in a speech parameter according to the other embodiment. As shown in FIG. 5, the embedding unit 415 comprises: a voiced excitation generation unit 4151 configured to generate voiced excitation based on said pitch parameter; an unvoiced excitation generation unit 4152 configured to generate unvoiced excitation; a combining unit 4154 configured to combine said voiced excitation and said unvoiced excitation into an excitation source; and an information embedding unit 4155 configured to embed said information into said excitation source.

Specifically, a pitch pulse sequence is generated as the voiced excitation by the voiced excitation generation unit 4151 by pass the pitch parameter through a pulse sequence generator. Moreover, the unvoiced excitation generation unit 4152 comprises a pseudo random noise number generator. A pseudo random noise is generated as the unvoiced excitation by the pseudo random noise number generator.

The voiced excitation and the unvoiced excitation are combined by the combining unit 4154 into an excitation source with U/V (unvoiced/voiced) decision in a time sequence. Generally, the excitation source is composed of a voiced part and an unvoiced part in a time sequence. The U/V decision is determined based on whether there is a fundamental frequency. The excitation of the voiced part is generally denoted by a fundamental frequency pulse sequence or excitation mixed with aperiodic components (such as a noise) and periodic components (such as a periodic pulse sequence), and the excitation of the unvoiced part is generally generated by white noise simulation.

In the embodiment, there is no limitation on the voiced excitation generation unit 4151, the unvoiced excitation generation unit 4152 and the combining unit 4154 for combining the voiced excitation and the unvoiced excitation, and detail description can be seen in non-patent reference 4 (“Mixed Excitation for HMM-base Speech Synthesis”, T. Yoshimura, etc. in Eurospeech 2001, all of which are incorporated herein by reference).

Preset information 30 is embedded by the information embedding unit 4155 into the excitation source combined by the combining unit 4154. In the embodiment, the information 30 is for example copyright information or text information etc. Before embedding, the information is firstly encoded as a binary code sequence m={−1, +1}. Then, a pseudo random noise PRN is generated by a pseudo random number generator. Then, the pseudo random noise PRN is multiplied with the binary code sequence m to transfer the information 30 as a sequence d. In the embedding process, the excitation source is used as a host signal S for embedding the information and a excitation source S′ with the information 30 is generated by adding the sequence d into the host signal S. Specifically, it can be obtained by the above formulae (1) and (2).

It should be understood that the method for embedding the information 30 by the information embedding unit 4155 is only an example of embedding information in a speech parameter of the present embodiment, any embedding method known by those skilled in the art can be used in the embodiment and the present embodiment has no limitation on this.

For the embedding unit with reference to FIG. 5, the information needed is embedded in the excitation source combined. Next, another example of the embedding unit 415 of the present embodiment will be described with reference to FIG. 6, wherein the information needed is embedded in an unvoiced excitation before combined.

FIG. 6 shows another example of the embedding unit 415 configured to embed information in a speech parameter according to the other embodiment. As shown in FIG. 6, the embedding unit 415 comprises: a voiced excitation generation unit 4151 configured to generate voiced excitation based on said pitch parameter; an unvoiced excitation generation unit 4152 configured to generate unvoiced excitation; an information embedding unit 4153 configured to embed said information into said unvoiced excitation; and a combining unit 4154 configured to combine said voiced excitation and said unvoiced excitation embedded with said information into an excitation source.

In the embodiment, the voiced excitation generation unit 4151 and the unvoiced excitation generation unit 4152 are same with the voiced excitation generation unit and the unvoiced excitation generation unit of the example described with reference to FIG. 5, detail description of which is omitted and which are labeled with same reference numbers.

Preset information 30 is embedded by the information embedding unit 4153 in the unvoiced excitation generated by the unvoiced excitation generation unit 4152. In the embodiment, the method for embedding the information 30 in the unvoiced excitation is same with the method for embedding the information 30 in the excitation source by the information embedding unit 4155, and before embedding, the information 30 is firstly encoded as a binary code sequence m={−1, +1}. Then, a pseudo random noise PRN is generated by a pseudo random number generator. Then, the pseudo random noise PRN is multiplied with the binary code sequence m to transfer the information 30 as a sequence d. In the embedding process, the unvoiced excitation is used as a host signal U for embedding the information and a unvoiced excitation U′ with the information 30 is generated by adding the sequence d into the host signal U. Specifically, it can be obtained by the above formulae (3) and (4).

In the embodiment, the combining unit 4154 is same with the combining unit of the example described with reference to 5, detail description of which is omitted and which is labeled with a same reference number.

Return to FIG. 4, in the embodiment, the speech synthesis unit 420 comprises a filter building unit configured to build a synthesis filter based on the spectrum parameter of the speech parameter generated by the parameter generation unit 410, and the excitation source embedded with the information is synthesized by the speech synthesis unit 420 into the speech with the information by using the synthesis filter, i.e. the speech with the information is obtained by passing the excitation source through the synthesis filter. In the embodiment, there is no limitation on the filter building unit and the method for synthesizing the speech by using the synthesis filter, and any method known by those skilled in the art such as those described in non-patent reference 1 can be used.

Moreover, optionally, the apparatus 400 for synthesizing a speech with information may further comprise a detecting unit configured to detect the information in the speech synthesized by the speech synthesis unit 420.

Specifically, in the case where the information is embedded in the excitation source by the embedding unit described with reference to FIG. 5, the detecting unit includes an inverse filter building unit configured to build an inverse filter based on the spectrum parameter of the speech parameter generated by the parameter generating unit 410. The revere filter building unit is similar to the filter building unit, and the purpose of building the inverse filter by the inverse filter building unit is to separating the excitation source from the speech. Any method known by those skilled in the art can be used to build the inverse filter.

The detecting unit may further comprise a separating unit configured to separate the excitation source with the information from the speech with the information by using the inverse filter, i.e. to obtain the excitation source S′ with the information 30 by passing the speech with the information through the inverse filter.

The detecting unit may further comprise a decoding unit configured to obtain the binary code sequence m by calculating a correlation function between the excitation source S′ with the information 30 and the pseudo random sequence PRN used when the information 30 is embedded into the excitation source S with the above formula (5), and to obtain the information 30 by decoding the binary code sequence m. Here, the pseudo random sequence PRN used when the information 30 is embedded by the information embedding unit 4155 into the excitation source S is a secret key for the detecting unit to detect the information 30.

Moreover, in the case where the information is embedded in the unvoiced excitation by the embedding unit described with reference to FIG. 6, the detecting unit includes an inverse filter building unit configured to build an inverse filter based on the spectrum parameter of the speech parameter generated by the parameter generating unit 410. The revere filter building unit is similar to the filter building unit, and the purpose of building the inverse filter by the inverse filter building unit is to separating the excitation source from the speech. Any method known by those skilled in the art can be used to build the inverse filter.

The detecting unit may further comprise a first separating unit configured to separate the excitation source with the information from the speech with the information by using the inverse filter, i.e. to obtain the excitation source S with the information 30 by passing the speech with the information through the inverse filter.

The detecting unit may further comprise a second separating unit configured to separate the unvoiced excitation U′ with the information 30 from the excitation source S′ with the information 30 by U/V decision. Here, the U/V decision is similar to that described above, detail description of which is omitted.

The detecting unit may further comprise a decoding unit configured to obtain the binary code sequence m by calculating a correlation function between the unvoiced excitation U′ with the information 30 and the pseudo random sequence PRN used when the information 30 is embedded into the unvoiced excitation U with the above formula (6), and to obtain the information 30 by decoding the binary code sequence m. Here, the pseudo random sequence PRN used when the information 30 is embedded by the information embedding unit 4153 into the unvoiced excitation U is a secret key for the detecting unit to detect the information 30.

Through the apparatus 400 for synthesizing a speech with information of the embodiment, the information needed can be embedded skillfully and properly in a parameter based speech synthesis system and high quality speech with many merits such as low complexity, safe and etc. can be achieved. Moreover, comparing with a general method of embedding information after a speech is synthesized, the apparatus 400 of the embodiment can ensure the confidentiality of the information-embedding algorithm and can greatly reduce computation cost and storage requirement, especially for small-footprint application. Moreover, it is safer to integrate an information-embedding module into a speech synthesis system since it needs more effort to keep this module away from the system. Moreover, if information is only added into the unvoiced excitation, it will be less perceptible to human hearing.

Though the method and apparatus for synthesizing a speech with information have been described in details with some exemplary embodiments, these above embodiments are not exhaustive. Those skilled in the art may make various variations and modifications within the spirit and scope of the present invention. Therefore, the present invention is not limited to these embodiments; rather, the scope of the present invention is only defined by the appended claims.

Specifically, the present invention can be used in any commercial TTS products that adopt parameter statistical speech synthesis algorithm to protect copyright. Especially for embedded voice-interface applications in TV, car navigation, mobile phone, expressive voice simulation robot and etc, it can be easily to implement. Moreover, it also can be used to hide useful information into voice such as speech text for web application.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for synthesizing a speech, comprising:
an inputting unit configured to input a text sentence;
a text analysis unit configured to analyze said text sentence so as to extract linguistic information;
a parameter generation unit configured to generate a speech parameter by using said linguistic information and a pre-trained statistical parameter model;
an embedding unit configured to embed information into said speech parameter; and
a speech synthesis unit configured to synthesize said speech parameter with said information embedded by said embedding unit into a speech with said information.

2. The apparatus for synthesizing a speech according to claim 1, wherein said speech parameter comprises a pitch parameter and a spectrum parameter, said embedding unit comprises:
a voiced excitation generation unit configured to generate voiced excitation based on said pitch parameter;
an unvoiced excitation generation unit configured to generate unvoiced excitation;
a combining unit configured to combine said voiced excitation and said unvoiced excitation into an excitation source; and
an information embedding unit configured to embed said information into said excitation source.

3. The apparatus for synthesizing a speech according to claim 2, wherein said speech synthesis unit comprises:
a filter building unit configured to build a synthesis filter based on said spectrum parameter;
wherein said speech synthesis unit is configured to synthesize said speech parameter embedded with said information into said speech with said information by using said synthesis filter.

4. The apparatus for synthesizing a speech according to claim 3, further comprising a detection unit configured to detect said information after said speech with said information is synthesized by said speech synthesis unit.

5. The apparatus for synthesizing a speech according to claim 4, wherein said detection unit comprises:
an inverse filter building unit configured to build a inverse filter based on said spectrum parameter;
a separating unit configured to separate said excitation source with said information from said speech with said information by using said inverse filter; and
a decoding unit configured to obtain said information by decoding a correlation function between said excitation source with said information and a pseudo random sequence used when said information is embedded into said excitation source by said information embedding unit.

6. The apparatus for synthesizing a speech according to claim 1, wherein said speech parameter comprises a pitch parameter and a spectrum parameter, said embedding unit comprises:
a voiced excitation generation unit configured to generate voiced excitation based on said pitch parameter;
an unvoiced excitation generation unit configured to generate unvoiced excitation;
an information embedding unit configured to embed said information into said unvoiced excitation; and
a combining unit configured to combine said voiced excitation and said unvoiced excitation embedded with said information into an excitation source.

7. The apparatus for synthesizing a speech according to claim 6, wherein said speech synthesis unit comprises:
a filter building unit configured to build a synthesis filter based on said spectrum parameter;
wherein said speech synthesis unit is configured to synthesize said speech parameter embedded with said information into said speech with said information by using said synthesis filter.

8. The apparatus for synthesizing a speech according to claim 7, further comprising a detection unit configured to detect said information after said speech with said information is synthesized by said speech synthesis unit.

9. The apparatus for synthesizing a speech according to claim 8, wherein said detection unit comprises:
an inverse filter building unit configured to build a inverse filter based on said spectrum parameter;
a first separating unit configured to separate said excitation source with said information from said speech with said information by using said inverse filter;
a second separating unit configured to separate said unvoiced excitation with said information from said excitation source with said information; and
a decoding unit configured to obtain said information by decoding a correlation function between said unvoiced excitation with said information and a pseudo random sequence used when said information is embedded into said unvoiced excitation.

10. A method for synthesizing a speech, comprising:
inputting a text sentence;
analyzing said text sentence inputted so as to extract linguistic information;
generating a speech parameter by using said linguistic information extracted and a pre-trained statistical parameter model;
embedding information into said speech parameter; and
synthesizing said speech parameter embedded with said information into a speech with said information.
